(19) United States
(12) Patent Application Publication
(10) Pub. No.: US 2019/0128785 A1
(43) Pub. Date: May 2, 2019

(54) COMPOSITIONS AND METHODS FOR TISSUE CLEARING

(71) Applicant: TEXAS A&M SYSTEM TECHNOLOGY COMMERCIALIZATION, College Station, TX (US)

(72) Inventors: Hu Zhao, College Station, TX (US); Dian Jing, College Station, TX (US); Shiwen Zhang, College Station, TX (US); Wenjing Luo, College Station, TX (US)

(21) Appl. No.: 16/176,360

(22) Filed: Oct. 31, 2018

Related U.S. Application Data
(60) Provisional application No. 62/579,232, filed on Oct. 31, 2017.

(51) Int. Cl. G01N 1/30

(52) U.S. Cl. CPC G01N 1/30

(57) ABSTRACT

The invention relates to reagents, solutions, kits, and methods for tissue clearing.

### CROSS REFERENCE TO RELATED APPLICATION

This application claims the benefit of U.S. Provisional Application No. 62/579,232, filed Oct. 31, 2017, entitled COMPOSITIONS AND METHODS FOR TISSUE CLEARING. The entire content of the foregoing is hereby incorporated by reference herein.

### FIELD OF THE INVENTION

The invention disclosed herein generally relates to reagents, solutions, kits, and methods for tissue clearing.

### BACKGROUND

3-dimensional visualization is the future of biomedical imaging. It provides many more details than conventional 2-D imaging technique and is extremely powerful for neural and vascular research. However, the 3-D visualization techniques have long been hindered by the opaque properties of the organ and tissue which block the light from going deeper. Tissue clearing techniques were therefore developed recently to make animal samples transparent. In this way, the fluorescent signal from the inside of the sample can be recorded without sectioning. Combining with latest confocal microscope or light sheet microscope, tissue clearing techniques provide a powerful tool to analyze biological samples in 3-dimensions. Some important applications for the tissue clearing technique include, but not limited to, (1) Neuron connection map acquisition; (2) innvervation study of various organs including bone, muscle and heart. (3) vasculature organization of organs.

Tissue opaqueness is mainly derived from heterogeneous optical properties among different tissue components. Tissue clearing techniques achieve transparency by eliminating RI mismatch within the tissue and decolorizing pigment elements^{1, 2}. Many tissue clearing methods have been developed, including 3DISCO, ScaleS, uDISCO, CLARITY, PACT, CUBIC, BoneClarity³ and others⁴⁻¹³ Current tissue clearing methods can be classified into two major categories: organic solvent-based and aqueous reagent-based. Organic solvent based approaches obtain high tissue transparency by using high RI clearing medium (R.I. 1.56), but are not efficient on clearing heavily colorized organs including liver, spleen and bone marrow. In addition, organic solvents severely compromise endogenous fluorescence. For example, GFP fluorescence level decreased by over 50% one month after placing in the uDISCO clearing medium. The aqueous methods usually have lower RIs (<1.49) and are more amenable for fluorescent protein. The clearing outcome is usually less than that of the solvent-based methods. Therefore, it is still beneficial to develop a more generalized clearing technique applicable for diverse tissues while preserving endogenous fluorescence.

### SUMMARY OF THE INVENTION

Some embodiments of the invention relate to a tissue clearing solution that can include a PEG, an organic ester, and a polyol. For example, the solution can include PEG, benzyl benzoate, and Quadrol. For example, the solution can include 65%-85% benzyl benzoate, 15%-30% PEG, and 0.5%-10% Quadrol. For example, the solution can include about 75 vol % benzyl benzoate (BB), about 22 vol % PEGMMA and about 3 vol % Quadrol.

Some embodiments of the invention relate to a kit for tissue clearing including the tissue clearing solution. In some embodiments, the kit can also include one or more of fixation reagent(s), decolorization reagent(s), delipidation reagent(s), dehydration reagent(s), clearing reagent(s), and/or the like. In some embodiments, the kit can also include one or more decalcification reagent(s).

Some embodiments of the invention relate to a method for clearing a tissue. The method can include: isolating the tissue; fixing the tissue in a fixing solution; decolorizing the tissue in a decolorizing solution; delipidating the tissue in a delipidating solution; dehydrating the tissue in a dehydration solution; and clearing the tissue in a tissue clearing solution. In some embodiments, the tissue becomes partially or completely transparent. In some embodiments, the method can further include decalcifying the tissue with a decalcification solution.

In some embodiments, the tissue can be brain, heart, spleen, kidney, liver, and/or the like. In some embodiments, the tissue can be bone, teeth, and/or the like.

Some embodiments of the invention relate to a method for clearing a whole body or large body part. The method can include fixing the body or large body part; decalcifying the body or large body part; decolorizing the body or large body part; delipidating the body or large body part; dehydrating the body or large body part; and clearing the body or large body part. In some embodiments, the body or large body becomes partially or completely transparent. In some embodiments, the method includes chemical reagents that are infused through a perfusion needle to access the whole body or body part.

Some embodiments of the invention relate to a method of 3-D visualization of a tissue, body, or body part using the methods and/or solutions disclosed herewith.

### BRIEF DESCRIPTION OF THE DRAWINGS

Those of skill in the art will understand that the drawings, described below, are for illustrative purposes only. The drawings are not intended to limit the scope of the present teachings in any way. The patent or application file contains at least one drawing executed in color. Copies of this patent or patent application publication with color drawing(s) will be provided by the Office upon request and payment of the necessary fee.

FIG. 1 depicts data using experiments related to an embodiment of the invention, coined Polyethylene Glycol (PEG) Associated Solvent System (PEGASOS) recirculation procedure. PEGASOS can efficiently clear the whole mouse body and enables imaging of large body parts. (a). Brief description of the PEGASOS recirculation procedure. (b-c), Adult CAG-EGFP mouse (2 months old) was imaged before (b) and after (c) the re-circulation procedure. The skin and eyeballs were removed to facilitate penetration. Other tissues including brain, bones, teeth, muscles and glands remained intact. (d-k). Body parts and internal organs were dissected after clearing. (l-q). After clearing, the whole head was imaged with a two-photon microscope in both ventral-to-dorsal (V-D) and dorsal-to-ventral (D-V) directions. The two image stacks were stitched together with Fiji 2.0. Panels (o-q) show optical sections acquired at different depths in the D-V direction. Scale bars in (c-q), 5 mm.

FIG. 2 depicts data from experiments related to PEGASOS passive immersion procedure can clear both hard and soft tissue organs and provides lossless protection for endogenous fluorescence. (a). Brief description of the PEGASOS passive immersion procedure for clearing hard tissue organs. (b). Femurs, short vertebrae segment (<3 cm length) and mandible were harvested from adult mice (60 days of age) and imaged before and after clearing. Dotted lines outline the organs after clearing. Arrows indicate teeth before and after clearing. (c). Short vertebrae from Tie2-Cre; Ail4 mice were imaged through the bone to reveal the vasculatures within. Boxed area is enlarged in (c′). (d). Tooth of Tie2-Cre; Ail4 was imaged after clearing to reveal the vascular network within the dental pulp. Boxed area is enlarged in (d′). (e). Brief description of the PEGASOS passive immersion procedure for clearing soft tissue organs. (f). Various soft tissue organs harvested from adult mice (60 days of age) were imaged before and after clearing. An intact liver lobe (g) and an intact kidney (h) harvested from adult Tie2-Cre; Ail4 mice (60 days of age) were imaged after clearing to reveal the vascular organization. Boxed areas are enlarged in (g′) and (h′) respectively. Arrows in (h′) indicate renal capsules. (i). Effects of BB-PEG clearing medium on GFP or tdTomato fluorescence over time. (j). Intestine samples were harvested from CAG-EGFP or Tie2-Cre; Ail4 mice and placed in the BB-PEG medium after clearing. Images were acquired at different time points. All values are mean±s.d. Statistical significance (*** P<0.001) was assessed by unpaired t-test. Scale bars in (b) and (f), 5 mm. Scale bars in (j), 1 mm.

FIG. 3 depicts data from experiments related to PEGASOS for whole brain imaging and tracking of individual neuron and axon. Adult (60 days of age) Thy1-EGFP mouse brain was cleared following the PEGASOS passive immersion procedure. The dorsal-to-ventral thickness of the brain is around 4 mm after processing. (a). Whole brain image acquired with a 10×/0.50 objective. Optical sections obtained at 2.0 mm and 3.5 mm are displayed in (b) and (c). Boxed areas are enlarged to show hippocampus (b1), cortical neuron (b2), cerebral peduncle (c1) and midbrain (c2). Tracking individual axons in 3-dimension requires objective with higher NA to achieve high axial resolution. (d). Tiling images acquired with a 20×/0.95 objective on a confocal microscope show the tracking course of one neuron and its axon in 3-dimension. Inset at the corner was acquired with a 5× objective at the plane where the target neuron is located. Two arrows indicate the approximate beginning and ending positions of the tracking. Boxed areas are enlarged in panels (d1) to (d4). Boxed area in (d1) is enlarged in the insert to show the dendritic spines. A, anterior; P, posterior; L, lateral; M, medial.

FIG. 4 depicts data from experiments related to PEGASOS PEGASOS can enable visualization of connections between CNS and PNS by imaging through the vertebrae. An adult Thy1-EGFP mouse (2 months old) was cleared following PEGASOS recirculation procedure and the vertebrae and brain were dissected for imaging. (a). The intact CNS together with DRGs was imaged with a 5×/0.16 objective. Boxed area is enlarged in the inlet to show individual DRG neurons. (b) The cervical vertebrae (dotted box in a) were re-imaged with a 10×/0.45 objective to visualize cervical DRGs C2-C6. Optical sections were acquired at boxed regions to show the multiple central axons (c) and DRG neurons (d). (e). Tracing of individual central axons. Each central axon (highlighted with color) gives rise to two daughter branches and then to multiple collateral branches (arrowheads). The entire tracing length is over 2 cm. (f-i). The C4 DRG was re-imaged with a 20×/0.95 objective to reveal connections between DRG neurons and the spinal cord. (g). Enlarged view shows neurons within the C4 DRG. (i). Eight pseudo-unipolar neurons were individually identified and artificially labeled with different colors (i1-i8). Their central axons can also be individually identified within the spinal cord (h). A, anterior; P, posterior; L, lateral; M, medial.

FIG. 5 depicts data from experiments related to PEGASOS showing that nerves and arteries have distinct distribution patterns within the long bone marrow space. (a). Thoracic cage from adult Wnt1-Cre; Ail4 mouse (2 months old) was cleared following the PEGASOS recirculation procedure and imaged with a two-photon microscope to display thoracic vertebrae, ribs, sympathetic trunks and spinal nerves (arrows) exiting the intervertebral foramina. (b). Dotted box in (a) is enlarged to display sympathetic ganglion (SG), DRG and the communication ramus (arrows) in between. (c). Nerve bundles in the femur periosteum. (d). Maximum Z projection of the tibia (˜1.5 mm thickness) imaged with a 10× objective shows the innervation within the bone marrow. Dotted areas are enlarged in panels (e-h). Arrows in (f) and (h) indicate nerve fibers penetrating the cortical bone. An intact tibia from αSMA-Cre^{ERT2}; Ail4 mice was cleared and imaged with a 10× objective on a two-photon microscope to visualize the arterial organization within the bone marrow near the metaphysis region (i) and the mid-shaft diaphysis region (j). (k). Nerves and arteries densities at different areas within the marrow space were quantified and normalized. Sampling locations are indicated with dotted lines in (d), (i) and (j). All values are mean±s.d., Statistical significance (*, P<0.05; **, P<0.01) was assessed by one way ANOVA.

FIG. 6 depicts data from experiments related to PEGASOS. PEGASOS passive immersion procedure can enable hard tissue organs clearing and imaging. Samples were harvested from adult mice (60 days age) and processed following the passive immersion procedure for hard tissue organs. Half of the skull was imaged with a stereomicroscope before (a) and after clearing (a′). (b). The cleared skull bone was imaged based on SHG signal acquired with a two-photon microscope. The intact mandible (c) and femur (e) were imaged with a two-photon microscope. Optical sections were obtained at boxed regions and enlarged in (c′) and (e′) respectively. (d). Tooth within the mandible was imaged with a two-photon microscope. Optical section was obtained to show the pulp chamber (d′). (f) and (f′). An intact knee joint was cleared. Optical sections acquired at different depth are displayed. Arrows indicate the articular surface. Articular ligaments are labeled.

FIG. 7 depicts data from experiments related to PEGASOS. CAG-EGFP mouse pups were processed with the PEGASOS passive immersion procedure. After fixation, the skin of 7-day-old mouse pups was removed and all other organs were left intact. The samples were cleared following the passive immersion procedure. Images were acquired before (a) and after (b) treatment. (c). Tiling image taken with a stereo fluorescent microscope. (d). The entire head presents complete transparency except pigmented eyes. The head was then imaged with a 5× objective on a two-photon microscope. (e-k) Whole head images are displayed from different angles including oblique (e), top (f) and bottom (g) views. Optical sections at 2.0 mm (h), 3.0 mm (i) and 5.0 mm (j) depth were obtained. Arrow in (j) indicates the trachea orifice. Boxed area in (j) was re-imaged with a 10× objective to demonstrate the bell stage tooth germ within the mandible (k). Scale bars in (e-j), 5 mm.

FIG. 8 depicts data from experiments related to PEGASOS. PEGASOS passive immersion procedure can enable soft tissue organs clearing and imaging. Samples were harvested from adult mice (60 days age) of or CAG-EGFP and processed following the passive immersion procedure. (a). Intact stomach of Tie2-Cre; Ail4 mouse was imaged before (a) and after clearing (a′). (b). The cleared stomach was imaged with a confocal microscope. Boxed area is enlarged in (b′) to show the vascular organization. (c). A segment of intestine was cleared to complete transparency (c′) and then imaged with a confocal microscope (d). Boxed area is enlarged in (d′) to display the vascular network. (e). An intact lung from a CAG-EGFP mouse was cleared (e′) and imaged (f). Boxed region is enlarged to display the branchial organization (f).

FIG. 9 depicts data using PEGASOS showing the size change of soft tissue organs after clearing. The figure shows the size change of various organs after clearing with PEGASOS passive immersion procedure. n=6.

FIG. 10 depicts data from experiments related to PEGASOS. Modified PEGs can preserve endogenous fluorescence. Intestine samples harvested from either CAG-EGFP or Tie2-Cre; Ail4 mice were harvested and processed following the PEGASOS passive immersion procedure. After dehydration, samples were placed in complete BB-PEG medium or benzyl benzoate only for evaluation. Fluorescent intensities were quantified with stereo fluorescence microscope at different time points after clearing. GFP (a) or tdTomato (b) fluorescence were preserved in BB-PEG medium, but were rapidly quenched by benzyl benzoate. To evaluate impact of various forms of PEG on the fluorescence intensity, dehydrated intestine samples were placed in clearing medium of different formulations (benzyl benzoate (75% v/v)+various PEGs (25% v/v)). Fluorescent intensities were measured one week after clearing. Different types of PEG within the BB-PEG medium have distinct effects on GFP (c) and tdTomato (d) fluorescence. All values are mean±s.d. Statistical significance (** P<0.01; * P<0.05) was assessed by one way ANOVA.

FIG. 11 depicts data from experiments related to PEGASOS. PEGASOS method can be compatible with immunofluorescent, GS-IB4 and EdU staining. (a). Brief description of the passive immersion procedure for whole mount tissue staining. (b-d). Whole-mount immunofluorescent staining of αSMA primary antibody was performed for heart, kidney and spleen slices of 1.5 mm thickness. Samples were then cleared following the PEGASOS passive immersion procedure and imaged with a confocal microscope. Boxed area in (c) is enlarged in panel (c′). (e-g). Whole mount immunofluorescent staining of laminin antibody was performed for brain slices (e), kidney slices (f) and intestine slices (g) of 1.5 mm thickness. Samples were imaged after clearing with a confocal microscope. Arrows in (f) show the renal capsules. (h). Colon samples were stained with GS-IB4 and then imaged after clearing. Boxed area is enlarged in (h′). (i). Adult mouse was injected with EdU two hours before sacrifice. The mandible was harvested for whole mount EdU staining and then imaged after clearing. Optical sections at the incisor region reveals highly proliferative cells at the apical region. Optical section was obtained at the boxed area and enlarged in (i′).

FIG. 12 depicts data from experiments related to PEGASOS. PEGASOS recirculation procedure can be scaled up for clearing adult rat. (a, b). Adult rat of 12 weeks age before (a) and after (b) clearing following the PEGASOS recirculation procedure. An adult (6 weeks age) mouse and a pup (p7) mouse after clearing were placed on the left as the size control. (c-j). Body parts and organs were dissected and imaged. Dotted lines outline the nearly invisible mandible within the BB-PEG clearing medium. Scale Bars, 1 cm.

FIG. 13 depicts data from experiments related to PEGASOS. The PEGASOS passive immersion procedure can be scaled up for clearing large tissue samples including human brain and dog bone. (a). Fixed human brain sample was cleared following the passive immersion procedure and achieved transparency (b). (c). A slice of human brain sample (1 mm thickness) was stained with laminin antibody and imaged after clearing. Boxed region is enlarged in c′ to show the vascular organization. (d). A bone piece (7 mm×3 mm×3 mm) harvested from dog tibia was cleared to achieve transparency (e). Cleared dog bone was imaged with a two-photon microscope and an image stack is displayed. Optical sections acquired at different depth are shown in panels (g), (h) and (i). (j). The laminin antibody staining followed by clearing reveals the Haversian Canals (arrows) located in the center of the osteon.

FIG. 14 depicts data from experiments related to PEGASOS. PEGASOS method can be applicable for the light sheet microscope imaging. A Thy1-EYFP mouse brain was processed with the PEGASOS passive immersion procedure. A selected region of interest (2 mm×2 mm×4 mm) was imaged with a 6×/0.25 objective on a TLS-SPIM light sheet microscope (3I Inc.) in 3D. (a) The 3D volume rendering of the ROI. (b) YZ maximum projection of the ROI. (c) A YZ axial slice of the ROI. (d-f) Optical sections were obtained from sub areas indicated in (b). (g-i) Three XY planes of the ROI at the 1 mm, 2 mm and 3.5 mm depth.

FIG. 15 depicts data from experiments related to PEGASOS demonstrating the tracing of individual neuron and axons in intact rat brain labelled with AAV. (a). Tiling image acquired with a 5×/0.15 objective on a confocal microscope demonstrates the plane of the AAV injection site. Areas in colored boxes were enlarged to visualize AAV-labeled neurons at the injection site and axons originating from them. (b). The tiling image was acquired with a 20×/0.95 objective to trace a neuron (yellow) from the injection site and its axon for ˜5.5 mm to near the midline area. Injection site (d) and the tracking end (g) were indicated in (a) with arrows. (c). Tail end view of the entire track showing collateral branches of the axon (arrows). Dotted boxed in (e) and (f) are enlarged in (e′) and (f′) respectively. (g). Collateral branches of the axon. A, anterior; P, posterior; L, lateral; M, medial.

FIG. 16 depicts data from experiments related to PEGASOS demonstrating the application of PEGASOS clearing tumor tissue samples harvested from human patients. (A). A piece of human tumor sample was stained with proprium iodine and cleared to complete transparency. (B). Cleared sample was imaged with a confocal microscope and 3-D image stack was displayed. (C). An optical section at 200 micron depth was demonstrated showing clear nuclear signals.

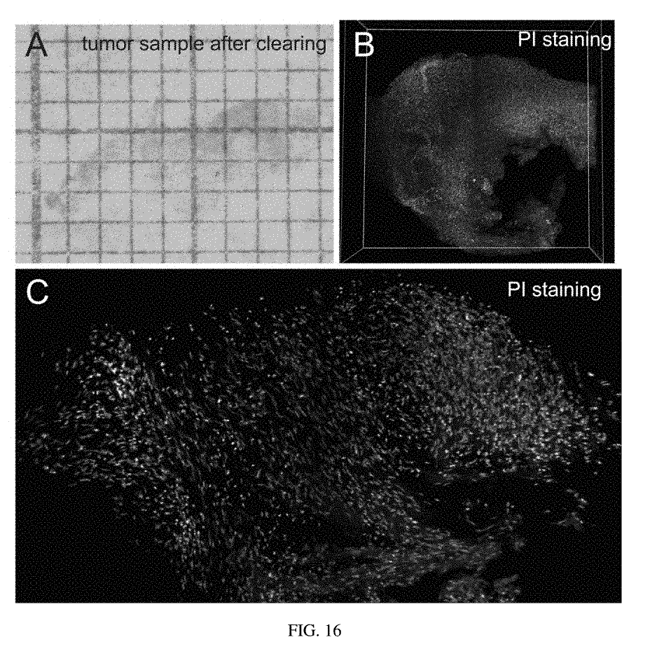

Videos related to the invention can be found on the Nature Neuroscience manuscripttrackingsystem under Manuscript # NN-T61374 at http://mts-nn.nature.com/cgi-bin/main.plex?e1=A4F2bmT1A3BYjF7F5A9ftduYGXsF3DmW3enDaMmDLUDwZ. These videos are incorporated herein by reference.

### DETAILED DESCRIPTION OF THE INVENTION

Unless otherwise noted, terms are to be understood according to conventional usage by those of ordinary skill in the relevant art.

Embodiments of the invention relate to reagents, solutions, kits, equipment and/or methods for a novel tissue clearing technique. The novel tissue clearing technique can be coined the Polyethylene Glycol (PEG) Associated Solvent System (PEGASOS).

Some embodiments of the invention relate to a tissue clearing solution. The solution can include a PEG or the like. The PEG can be PEGMMA, PEGDA (Sigma-Aldrich), PEGDMA (Sigma-Aldrich), PEG200, PEG400, or PEG1000 (Sigma-Aldrich). The clearing solution can include an organic ester or the like. The clearing solution can include a polyol. The clearing solution can include 55-95 vol % organic ester (Sigma-Aldrich), 1-40 vol % PEGMMA (Sigma-Aldrich) and 0.1-10 vol % polyol. For example, the clearing solution can include 75 vol % benzyl benzoate (BB) (Sigma-Aldrich), 22 vol % PEGMMA (Sigma-Aldrich) and 3 vol % Quadrol (Sigma-Aldrich). The fresh solution can be a colorless liquid with low viscosity and can turn slightly yellow in a week.

Some embodiments of the invention relate to a decalcification solution. The solution can include EDTA or the like. The solution can include 1-40% (w/v) EDTA. For example, the solution can be prepared by mixing 20% (w/v) Ethylenediaminetetraacetic acid (EDTA) (Sigma-Aldrich) with H2O. Sodium hydroxide (Sigma-Aldrich) can added to adjust the pH to 7.0.

Some embodiments of the invention relate to one or more decolorization solutions. The solution can include a polyol and or Ammonium, or the like. The solution can include 5-40 vol % polyol. The solution can include 1-20 vol % Ammonium. For example, Quadrol (Sigma-Aldrich) can be diluted with H2O with a final concentration of 25 vol %. For example, Ammonium (Sigma-Aldrich) can be diluted with H2O with a final concentration of 5 vol %.

Some embodiments of the invention relate to a delipidation solution. The solution can include Pure tert-Butanol (tB) or the like. The solution can include a polyol or the like. The solution can include gradient solutions of Pure tert-Butanol (tB) from 15-90 vol %. The solution can include 0.5%-10% vol % Quadrol to adjust the pH. For example, pure tert-Butanol (tB) (Sigma-Aldrich) can be diluted with distilled water to prepare gradient delipidation solutions: 30 vol %, 50 vol % and 70 vol % and Quadrol (Sigma-Aldrich) can be added with 3 vol % final concentration to adjust the pH over 9.5.

Some embodiments of the invention relate to a dehydration solution. The solution can include tert-Butanol or the like. The solution can include a PEG or the like. The solution can include a polyol or the like. The solution can include 50-90 vol %-Butanol. The solution can include a 10-40 vol % PEG. The solution can include 0.1-15 vol % polyol. For example, the dehydrating solution can include of 70 vol % tert-Butanol, 27 vol % PEG methacrylate (PEGMMA) (Sigma-Aldrich) and 3 vol % Quadrol (Sigma-Aldrich).

Some embodiments of the invention relation to kit for tissue clearing. The kit can include tissue clearing regent(s). The kit can include one or more of fixation reagent(s), decolorization reagent(s), delipidation reagent(s), dehydration reagent(s) and/or clearing reagent(s). For hard tissue clearing, the kit can additionally include decalcification reagent(s).

Some embodiments of the invention related to a method for tissue clearing, the method can efficiently render nearly all hard and soft tissue organs partially or completely transparent. The method can efficiently clear both hard and soft tissue highly transparent and protect endogenous fluorescence for a long time with no intensity loss. High transparency and superior fluorescence preservation enables one to acquire more details within a neural tissue. In some embodiments of the invention, the method can achieve about 50, 60, 70, 80, 90, or 100% transparency.

In some embodiments of the invention, the method can be used on bone, teeth, brain, heart, spleen, kidney and liver, and the like.

In some embodiments, the method can restore and preserve endogenous fluorescence over a period of time. The period of time can be about 1, 2, 3, 4, or 5 more months.

The method can include multiple steps such as fixation, decalcification (hard tissue only), decolorization, delipidation, dehydration and clearing.

The method can be a recirculation procedure for clearing the whole body or large body parts. In the recirculation procedure, chemical reagents can be infused through the whole body or large body part. For example, the reagents can be infused through a perfusion needle left in the left ventricle to access the entire body.

The method can be a passive immersion procedure for clearing individual organs or small body parts. In the passive immersion procedure, the organs or parts can be immersed in chemical reagents. The immersions can be done in subsequent steps.

The method is composed of multiple steps with various chemical reagents with different recipes. Some embodiments of the invention relate to the special chemical products, kits, and equipment developed for using the method.

Some embodiments of the invention relate to a method of 3-D visualization of a tissue. The method can include an imaging agent. The method can include microscopy or any such visualization means. For example, the method can include use of Zeiss AxioZoom V16 Stereomicroscopy, Zeiss LSM 780 two-photon microscopy, Zeiss LSM 880 two-photon microscopy and/or Leica TCS SP8 confocal microscopy and/or the like.

In some embodiments, the method can be used to track individual axons and neurons over a long distance within intact brains. In some embodiments, the method can be used to image the dorsal root ganglions (DRGs) in vertebrate bone. In some embodiments, the connection between the peripheral nervous system (PNS) and the central nervous system (CNS) can be observed. In some embodiments, the method can be used to see inside a bone to capture the vascular and neural organization (e.g., nerve distribution pattern) within the long bone marrow space, which can be a critical issue for both hematopoietic stem cell (HSC) and mesenchymal stem cell (MSC) niche studies, which to date, have been difficult to study.

Having described the invention in detail, it will be apparent that modifications, variations, and equivalent embodiments are possible without departing the scope of the invention defined in the appended claims. Furthermore, it should be appreciated that all examples in the present disclosure are provided as non-limiting examples.

### EXAMPLES

The following non-limiting examples are provided to further illustrate embodiments of the invention disclosed herein. It should be appreciated by those of skill in the art that the techniques disclosed in the examples that follow represent approaches that have been found to function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

### Example 1

### Experiments

Materials and Methods for the experiments described in the following Examples are provided below.

### Animals

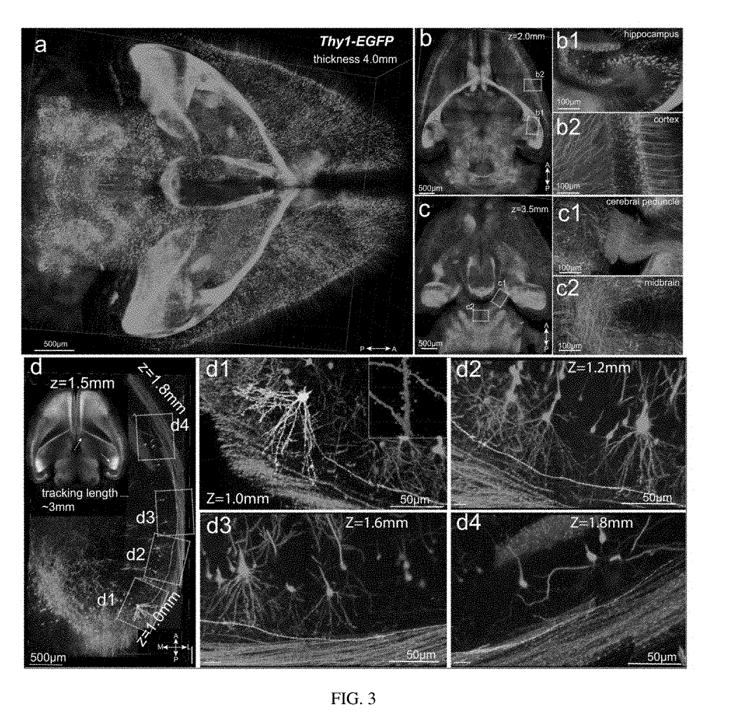

Adult mice (6-8 weeks age), both male and female, with genotypes including C57BL/6 (JAX #000664), Thy1-eGFP-M (JAX 007788), Wnt1-Cre (JAX022137), αSMA-Cre^{ERT2}, Tie2-Cre (JAX 008863), Ail4 (JAX 007908) and CAG-EGFP (JAX 003291) were used in the experiments. Mouse pups of p7 age, with genotype CAG-EGFP, were used for experiments in Supplementary FIG. 3. Sprague Dawley rat (300 gram) (Charles River 400) of both male and female were used for experiments. Dog tibia bone samples were donated by Dr. Jian Q. Feng of the Texas A&M University. Human brain tissue samples were donated by Dr. Woo-Ping Ge of the UT Southwestern Medical Center. All animal experiments were approved by the Institutional Animal Care and Use Committee of UT Southwestern Medical Center and the Texas A&M University and were in accordance with guidelines from the NIH/NIDCR.

Preparation of PEGASOS solutions

Decalcification Solution

Decalcification solution was prepared by mixing 20% (w/v) Ethylenediaminetetraacetic acid (EDTA) (Sigma-Aldrich) with H₂O. Sodium hydroxide (Sigma-Aldrich) was added to adjust the pH to 7.0.

Decolorization Solutions

Quadrol (Sigma-Aldrich) was diluted with H₂O with a final concentration of 25 vol %. Ammonium (Sigma-Aldrich) was diluted with H₂O with a final concentration of 5 vol %.

Gradient tB Delipidation Solution

Pure tert-Butanol (tB) (Sigma-Aldrich) was diluted with distilled water to prepare gradient delipidation solutions: 30 vol %, 50 vol % and 70 vol %. Quadrol (Sigma-Aldrich) was added with 3 vol % final concentration to adjust the pH over 9.5.

tB-PEG Dehydration Solution

Dehydrating solution was composed of 70 vol % tert-Butanol, 27 vol % PEG methacrylate (PEGMMA) (Sigma-Aldrich) and 3 vol % Quadrol (Sigma-Aldrich).

BB-PEG Clearing Medium (Refractive Index R.I. 1.543)

BB-PEG was prepared from mixing 75 vol % benzyl benzoate (BB) (Sigma-Aldrich), 22 vol % PEGMMA (Sigma-Aldrich) and 3 vol % Quadrol (Sigma-Aldrich) together. The fresh medium was a colorless liquid with low viscosity and turned slightly yellow in a week. Other forms of PEGs including PEGDA (Sigma-Aldrich), PEGDMA (Sigma-Aldrich), PEG200, PEG400 and PEG1000 (Sigma-Aldrich) were also used for comparing their fluorescence preservation capabilities.

### Perfusion and Tissue Preparation

Before transcardiac perfusion, mice were anesthetized with an intraperitoneal injection of a combination of xylazine and ketamine anesthetics (Xylazine 10-12.5 mg/kg; Ketamine, 80-100 mg/kg body weight). For mice, 50-100 ml ice-cold heparin PBS (10U/ml heparin sodium in 0.01M PBS) was injected transcardially to wash out the blood. 50 ml 4% PFA (4% paraformaldehyde in 0.01M PBS, pH 7.4) was then infused transcardially for fixation. For rats, a circulation pump (VWR 23609-170) was applied to supply sufficient perfusion pressure and speed, and 500-1000 ml fresh heparin PBS and 500 ml 4% PFA were circulated to perfuse.

For the whole-body tissue clearing procedure, the skin, eyeballs and tongue were removed. The contents of the stomach and gut were flushed out with PBS. For immersion of individual organs, the organs under study were dissected and immersed in 4% PFA at room temperature for 24 hours before proceeding to tissue clearing.

Whole Body Clearing with the PEGASOS Recirculation Procedure

Immediately following standard transcardiac perfusion with heparin PBS (10U/ml heparin sodium in 0.1M PBS), the mice were perfused with 4% PFA (in PBS, pH 7.4) and fixed at room temperature for 24 hours. The mice were then transferred into a perfusion chamber at 37° C. for recirculation of all reagents sequentially driven by a peristaltic pump (VWR 23609-170). The mice were perfused with 20% EDTA (pH 8.0) for four days for decalcification and then pure water (pH7.0) for two hours to wash out the resulting salt. 25% Quadrol decolorization solution was perfused for two days and 5% ammonium decolorization solution was perfused for one day for decolorization. 30 vol % 50 vol % and 70 vol % tB delipidation solutions were sequentially perfused for delipidation at one day per concentration. The mice were then dehydrated with the tB-PEG medium for two days. The mice were finally perfused with the BB-PEG clearing medium until the tissue turned transparent, which usually took 24 hours. Samples can be preserved in the BB-PEG clearing medium at room temperature for preservation. A typical recirculation clearing process took two weeks to complete.

For clearing adult rats (>300 g) with the recirculation procedure, the duration for each step was doubled and the entire clearing process took one month to complete.

### PEGASOS Passive Immersion Procedure

For clearing hard tissue samples, 4% PFA fixation was performed at room temperature for 24 hours and then samples were immersed in 20% EDTA (pH 7.0) at 37° C. temperature in a shaker for four days. Samples were then washed with H₂O for at least 30 mins to elute excessive EDTA. Following that, samples were decolorized with the Quadrol decolorization solution for two days and the ammonium solution for half day at 37° C. in a shaker. Samples were placed in gradient tB delipidation solutions for 1-2 days and then tB-PEG for 2 days for dehydration. Samples were then immersed in the BB-PEG medium for at least one day for clearing.

For soft tissues or tissue slices, decalcification procedure was not needed. After 24 hours fixation with 4% PFA solution, samples were treated with Quadrol decolorization solution for 2 days and 5% ammonium decolorization solution for 0˜1 day at 37° C. Samples were then immersed in gradient delipidation solutions at 37° C. shaker for 1 to 2 days, followed by dehydration solution treatment for 1 to 2 days and BB-PEG clearing medium for at least 1 day until reaching transparency. Samples were then preserved in the clearing medium at room temperature.

An example time schedule for clearing different types of tissue with PEGASOS immersion method can be summarized in the following table (tissue type/reagents).

TABLE 1
PEGASOS immersion method time schedule.

| | | | | | Tissue slices 2 mm | |
|---|---|---|---|---|---|---|
| | Soft tissue organs | | Hard tissues | | thick | |
| 20% EDTA | none | | 4 | days | None | |
| 25% EDTP | 2 | days | 2 | days | 1 | day |
| 5% Ammonium | 0.5~1 | day | 1 | day | 0~0.5 | day |
| 30% tert-butanol | 4 | hr | 4 | hr | 2 | hr |
| 50% tert-butanol | 6 | hr | 6 | hr | 4 | hr |
| 70% tert-butanol | 1 | day | 1 | day | 4 | hr |
| tB-PEG | 2 | days | 2 | days | 1 | day |
| BB-PEG | 1 | day | 1 | day | 0.5 | day |
| Total time | 7-8 | days | 11.5 | days | 3-4 | days |

Measurement of the Organ Size Change after Treatment.

Dissected organ samples before and after treatment were imaged with a stereo microscope (Olympus SZX16) under the same magnification. Sample area was outlined and quantified in ImageJ (NIH). The area after treatment was divided by the area before treatment for normalization.

Vasculature Labeling with the Isolectin GS-IB₄ Dye:

Adult mice of 6-8 weeks of age were placed in a restrainer after anesthesia. The tail was warmed with a heat lamp for about 1 min and then wiped with 70% ethanol around the injection site. A 30G needle was inserted with the bevel up, going 5˜15 degrees into the vein. Two hundred microliters of 500 μg/ml AlexFluo568 conjugated GS-IB₄ (Thermofisher, 121412) was injected. Mice were sacrificed 10 minutes later with CO₂ for sample collection.

### Fluorescence Intensity Quantification

Intestine slices (2 mm×2 mm) were harvested from adult CAG-EGFP or Tie2-Cre; Ail4 mice as the test sample. Fluorescent images were captured with a stereo fluorescence microscope (Zeiss AxioZoom. V16) with the same imaging parameters for all testing groups. Fluorescence intensity values were measured using the Fiji 2 “measure” function and were calculated as the difference between the “mean grey value” of the sample and the background. The initial time point, DO, was set at 1h after immersing samples into the clearing medium. Afterwards, measurements were made at indicated time points. The DO fluorescence value was normalized as 1.00 and the ratio of other time points to DO was used as the relative fluorescence intensity. When evaluating the fluorescence preservation properties of different PEGs, the fluorescence intensity value ratio of D7 to DO was used to evaluate the remaining fluorescence intensity.

### Neural and Arterial Density Calculation

Calculation of neural and arterial density was performed on 3D reconstituted tibia imaged with a 20× objective. Adult αSMA-Cre^{ERT}; Ail4 mouse model (P60) was used for labeling arteries. Adult Wnt1-Cre mouse model (P60) was used for labeling nerves. Measurement was performed in three areas including diaphysis, metaphysis and the junction area between them. For each area, at least three samples were used for quantification. Numbers of vessels or nerves were counted in unit volume. The density value is given as (Number of nerves or arteries/Unit volume (μm³). Diaphysis density value was normalized as 1.0. Density values in other regions were divided by the diaphysis value for normalization. Statistical analysis was performed using one-way ANOVA and Tukey's multiple comparisons test.

### Microscopy and Image Analysis

Whole-body and -organ fluorescent images were acquired with Zeiss AxioZoom V16 Stereomicroscopy, Zeiss LSM 780 two-photon microscopy, Zeiss LSM 880 two-photon microscopy or Leica TCS SP8 confocal microscopy.

A tiling light sheet selective plane illumination microscope (TLS-SPIM), designed and constructed by the 3I Inc. (Intelligent Imaging Innovations, Inc., Denver, Colo.) was used to image the cleared Thy1-EYFP brain sample²¹. A tiling light sheet tiled at multiple positions within the field of view was used to illuminate the sample, and the sample was scanned with a 6×/0.25 NA objective axially at a ˜2 μm step size to image the selected region of interests in 3D.

Imaging processing and 3D rendering was performed with a Dell Precision T7600 workstation with dual Xeon 2670 processor, 128 GB RAM and AMD Radeon 480 graphic card.

All raw image data were collected in a lossless 16-bit TIFF format. Blind deconvolution processing was performed using Autoquant X3 (Media Cybernetics). Tiling of multiple image stacks were performed using Image J (1.51H, NIH). Image 3D reconstructions and movies were generated using Imaris X64 software (version 8.3.1, Bitplane). Stack images were reconstructed using the “volume rendering” function. Optical slices were obtained using the “orthoslicer” function. 3D pictures were generated using the “snapshot” function. Movies were generated using “animation” function.

Neuronal Labeling with Adeno-Associated Viruses (AAV)

The AAV9-Synapsin1-tdTomato virus was purchased from the UNC virus vector core (# AV6389). The tdTomato gene expression is under the control of the neuronal-specific synapsin-1 promoter. Adult mice (6-8 weeks) or rats (12-20 weeks) were anesthetized with a ketamine/xylazine mixture (120 mg/kg and 16 mg/kg body weight, respectively). A skin incision (8-10 mm) was made over the skull. The Kopf stereotaxic instrument was used to locate the injection site (−2.46, −2.6, −2.36 in hippocampal CA3 for mice, −3.3, −3.7, −3 for rat CA1 region of the hippocampus). A 0.5 mm diameter hole was drilled in the skull with a microdrill (Fine Science Tools). A glass capillary with 50-μm tip attached to a micropipette holder was inserted to the appropriate depth below the skull. Each animal was injected with 0.1 μl of the concentrated (4×10¹² particles/μl) AAV suspension in PBS. The glass capillary was kept in place for 5 min and then slowly pulled out after the injection. The incision was then sutured. Animals were placed on a heat pad for recovery. Animals were sacrificed 4 weeks later for further analysis.

### Whole-Mount Immunohistochemical Staining

1.5 mm thick sections of various organs were used for whole-mount immunohistochemical staining. After fixation with 4% for 24 hours, samples were decolorized with 25% Quadrol for 1 day and 5% ammonium solution for 4 hours. Next, samples were washed with the PBS solution for 30 minutes. Samples were then immersed in the blocking solution composed of 10% dimethyl sulfoxide (Sigma-Aldrich 276855), 0.5% IgePal630 (Sigma-Aldrich 18896) and 1× casein buffer (Vector, SP-5020) in 1 ml 0.01M PBS for blocking overnight at room temperature. After blocking, samples were stained with the primary antibody diluted with the blocking solution for 72 hours at 4° C. on a shaker. Tissues were then washed with PBS at room temperature for one day. After that, samples were stained with the secondary antibodies diluted with the blocking solution for another three days at 4° C. on a shaker. PBS wash was performed for the samples for 6 hours. Samples were then moved to the delipidation and dehydration solutions following the passive immersion procedure protocol. After final clearing with the BB-PEG medium, samples were maintained in the clearing solution for imaging.

Antibodies used for whole-mount staining included αSMA FITC antibody produced in mouse (dilution 1:500, Sigma-Aldrich F3777), rabbit anti-Laminin antibody (dilution 1:50, Sigma-Aldrich L9393), goat anti-mouse IgG Alexa Fluor 488 and goat anti-rabbit IgG Alexa Fluor 488 (dilution 1:200, ThermoFisher A-11029 and A11034).

### Whole-Mount 5-Ethynyl-2′-Deoxyuridine (EdU) Incorporation Assay

Adult C57BL/6 mice (60 days of age) were used for EdU incorporation assay. Edu (Invitrogen, E104152) was injected intraperitoneally at a dosage of 1 mg/10 g of mouse body weight. Mice were sacrificed two hours after injection and the mandibular bones were collected for fixation in 4% PFA for 24 hours. The samples were then processed following the PEGASOS passive immersion procedure for the hard tissue. After the decolorization treatment, the samples were immersed in the EdU labeling cocktail (Invitrogen Click-iT EdU imaging kit) for 3 days. Samples were then washed with PBS for 2 hours and then placed in the delipidation medium, dehydration medium and the clearing medium until transparency was achieved.

### Quantification and Statistical Analysis

N number are reported in the figures and corresponding legends. Data are presented as mean±standard deviation using Student's t tests or one-way ANOVA. Statistical analysis was performed in Microsoft Excel and GraphPad Prism.

### Example 2

### PEGASOS is Applicable for Clearing Whole Body and Imaging Large Body Parts

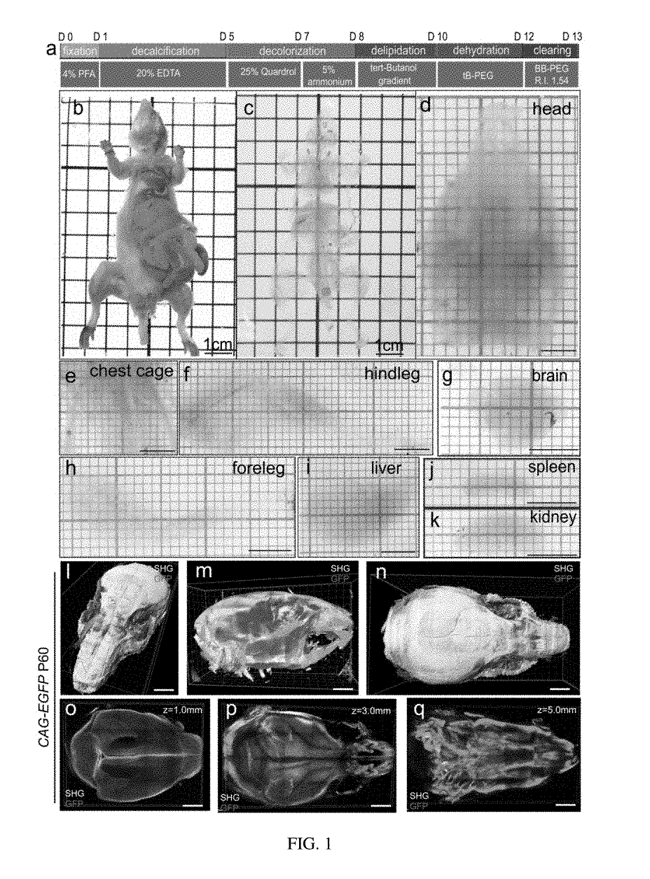

The PEGASOS method is consisted of multiple steps including fixation, decalcification (hard tissue only), decolorization, delipidation, dehydration and clearing (FIG. 1 a). It can be performed in two approaches, the recirculation procedure for clearing the whole body or large body parts and the passive immersion procedure for clearing individual organs or small body parts. In the recirculation procedure, chemical reagents were infused through a perfusion needle left in the left ventricle to access the entire body. After 4% PFA fixation, 20% Ethylenediaminetetraacetic acid (EDTA) solution was first perfused to decalcify the hard tissue. Next, 25% N,N,N′,N′-Tetrakis(2-Hydroxypropyl)ethylenediamine (Quadrol) in H₂O solution was adopted as the decolorizing reagent¹. Ammonium solution was widely used for dissolving heme and for whitening bone samples in taxonomy^{14, 15}. Therefore, 25% Quadrol and 5% ammonium solutions were combined in sequence for decolorizing samples (FIG. 1 a).

Methanol was used for dehydration in the iDISCO method^{16, 17}, Tetrahydofuran (THF) was used for dehydration in the 3DISCO method^{8, 18}. Both of them may cause severe quenching of GFP fluorescence. Tert-Butanol (tB) supplemented with vitamin E was used in the uDISCO for dehydration, which provides better protection for GFP fluorescence⁷. tB supplemented with 3% Quadrol was applied for delipidation. The Quadrol component functions to maintain the solution at pH 9.0. tB-PEG reagent was designed for dehydration, which is composed of 75% tB+22% Poly(ethylene glycol) methacrylate (PEGMMA)+3% Quadrol. For final tissue clearing, a BB-PEG medium (RI 1.543) was designed, which is composed of 75% benzyl benzoate (BB), 22% PEGMMA and 3% Quadrol.

The whole body of adult mice (60 days of age) was cleared. After perfusing the mice with 4% PFA, all the organs were kept except the skin and eyeballs being removed (FIG. 1 b). A typical recirculation clearing procedure took 12 days to finish (FIG. 1 a). After clearing, the entire mouse body turned transparent. The grids in the background can be clearly visualized through the body. The size of the body also shrunk significantly (FIG. 1 c). Body parts including the entire head (containing the brain), thorax, and both front and hind legs were highly transparent, suggesting successful clearing of all tissues on them. Complete transparency was also obtained for internal organs including the brain, liver, kidney and spleen (FIG. 1 d-k).

The recirculation procedure achieved high transparency of large body parts, which enabled the imaging of an adult mouse head composed of bones, muscles, brains and other tissues. The cleared head of a CAG-EGFP mouse was imaged with 5×/0.16 objective on a two-photon microscope. Second Harmonic Generation (SHG) fluorescence signal was used to show collagen-rich tissue such as bones and teeth. GFP fluorescence was used for imaging soft tissue because hard tissue contains fewer cellular components and displays weaker GFP fluorescence. The head (˜10 mm in dorsal-to-ventral direction) was imaged in both the dorsal-to-ventral (6 mm Z Stack) and ventral-to-dorsal (4 mm Z stack) dimensions. The two stacks were stitched together with Fiji 2.0 to form a complete image stack (FIG. 1 l, m, n). Optical sections obtained at 1 mm, 3 mm and 5 mm depths revealed internal structures (FIG. 1 o, p, q).

### Example 3

### PEGASOS Passive Immersion Method Efficiently Clears Both Hard and Soft Tissues

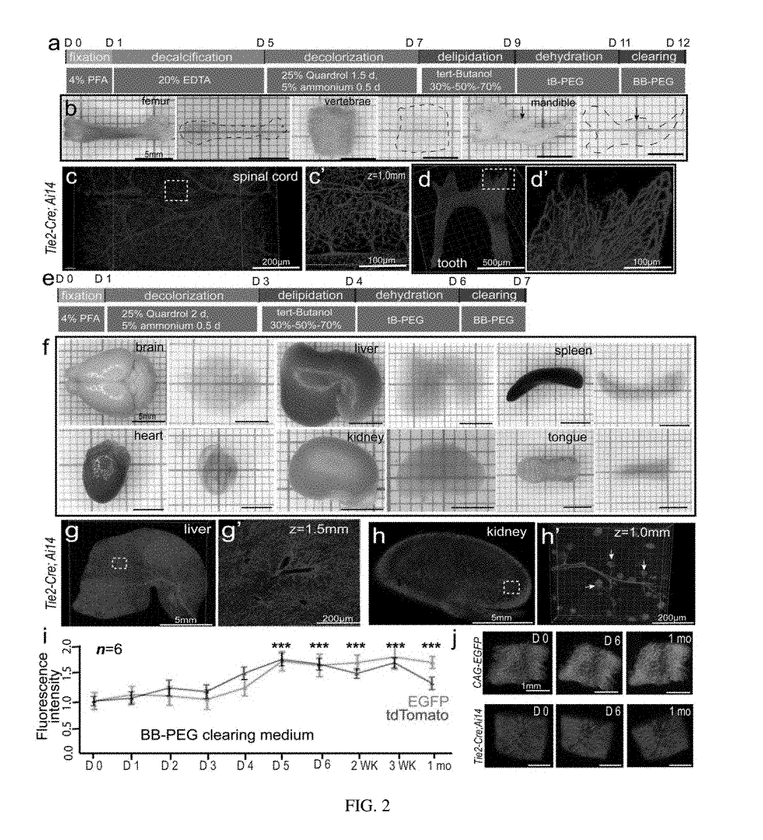

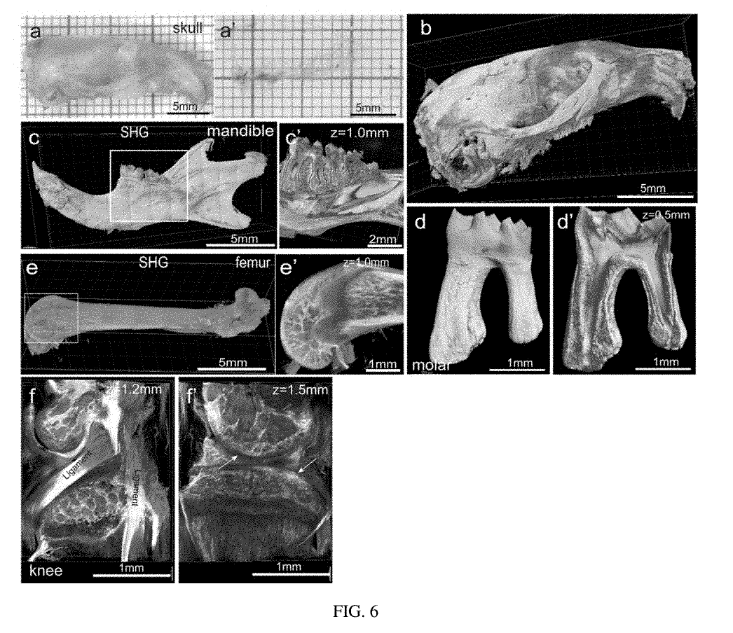

The PEGASOS method can also be performed following the passive immersion procedure. For hard tissue, twelve days were needed for final clearing (FIG. 2 a). Intact femur, short vertebrae segment (less than 3 cm length), mandible together with teeth and half skull was cleared to nearly invisible (FIG. 2 b, FIG. 6 a, a′). The vertebrae segment of Tie2-Cre; Ail4 mouse was imaged with a confocal microscope and visualized the vasculatures network within the spinal cord (FIG. 2 c, c′). Tooth enamel and dentin are the hardest tissue in the body¹⁹. By imaging the teeth on a cleared mandible of Tie2-Cre; Ail4 mouse, visualization of the enriched vascular network encapsulated by enamel and dentin was achieved (FIG. 2 d, d′).

Based on the SHG fluorescent signal, hard tissue samples in 3-dimension were reconstituted. Half of the skull bone was reconstituted with a 5×/0.16 objective on a two-photon microscope (FIG. 6 b). The entire mandible was reconstituted with a 10×/0.30 objective on a two-photon microscope. Optical section of the mandible image revealed the teeth within (FIG. 6 c, c′, video 1). The first molar on the mandible was re-imaged with a 20×/0.5 objective to achieve better resolution and details (FIG. 6 d, d′). The entire femur was reconstituted with a 10×/0.3 objective and optical sections revealed the trabecular bone structure within (FIG. 6 e, e′, video 2). The knee joint was reconstituted and optical sections were obtained at different levels to show the articular surfaces and ligaments (FIG. 6 f, f′).

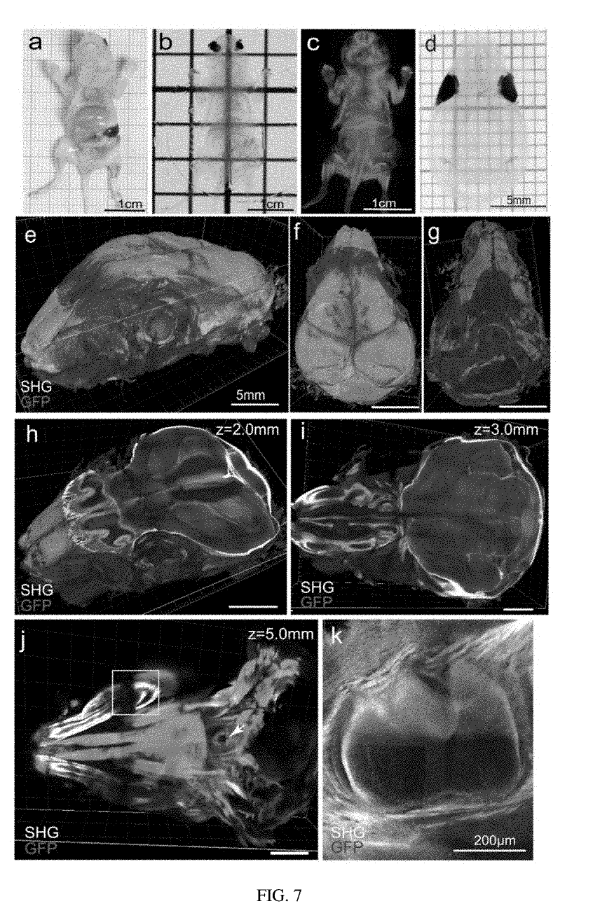

Although adult full body clearing requires the recirculation procedure, whole body of young mouse pups could be cleared following the passive immersion procedure for the hard tissue due to their smaller size. A CAG-EGFP mouse pup of postnatal day 7 age (p7) was cleared to fully transparent 12 days after fixation except the pigmented eyes (FIG. 7 a, b). The endogenous GFP fluorescence signal was very well preserved (FIG. 7 c). The head containing the brain was removed for imaging with a 5×/0.16 objective in both the dorsal-to-ventral (5 mm Z stack depth) and ventral-to-dorsal directions (1 mm Z stack depth). After stitching the two stacks together, 3D reconstitution showed intact head organization with SHG and GFP signal clearly distinguishing the soft and hard tissue (FIG. 7 e, f, g, video 3). Optical sections obtained at 2 mm and 3 mm in depth revealed the internal structures including the brain and nasal cavity (FIG. 7 h, i). An optical section obtained at 5 mm depth revealed the trachea orifice (FIG. 7 j). Re-imaging selected area with a 10×/0.3 objective revealed the tooth germ embedded within the mandible (FIG. 7 k).

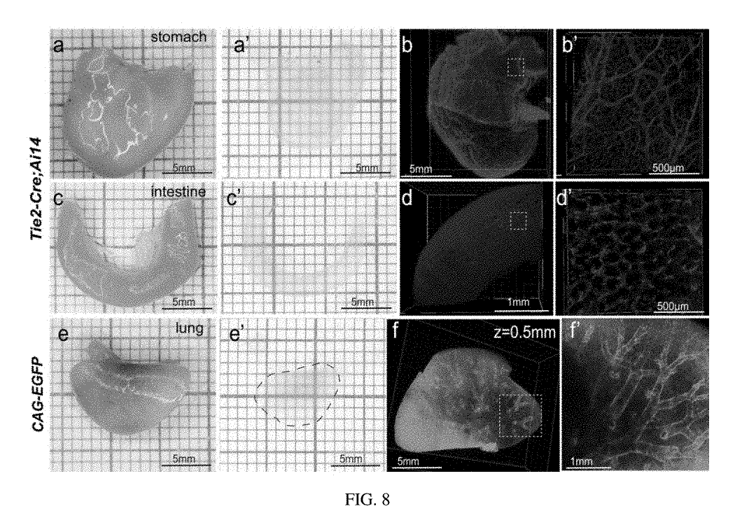

The PEGASOS passive immersion procedure could clear soft tissue organs in a much shorter time because decalcification is not needed. Within seven days, the brain, liver lobe, spleen, heart, kidney, stomach, intestine and lung to were cleared to complete transparency (FIG. 2 f; FIG. 8 a, a′, c′ c′, e, e′). The liver lobe and kidney harvested from Tie2-Cre; Ail4 mice was imaged and reconstituted with a confocal microscope. Optical sections obtained at various level revealed the vasculature organization within the liver and kidney (FIG. 2 g, g′, h, h′). The intact stomach was imaged and reconstituted and intestine harvested from Tie2-Cre; Ail4 mice and optical sections revealed the vasculatures in both organs (FIG. 8 b, b′, d, d′). The right lung from a CAG-EGFP mice was imaged and reconstituted. Optical sections revealed the bronchi organization (FIG. 8 f, f′).

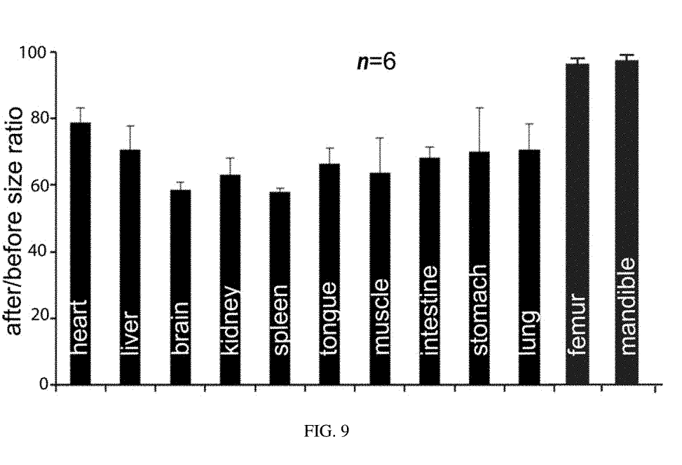

PEGASOS method also caused significant shrinkage of the soft tissue organs. The shrinkage ratio varied between 30% (heart, liver) and 40% (brain, spleen). The PEGASOS method did not lead to significant shrinkage of the bone samples tested (FIG. 9)

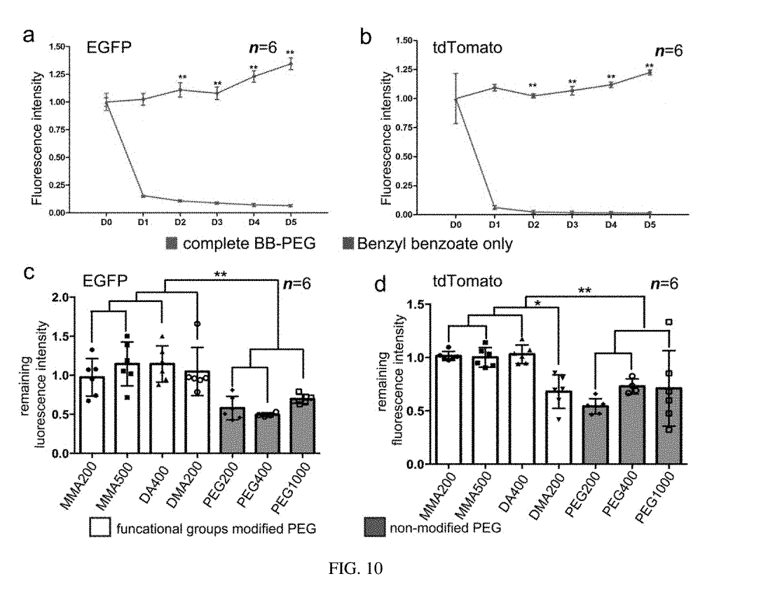

To evaluate impact of BB-PEG clearing medium on the endogenous fluorescence, quantified assays were performed using intestine samples harvested from either CAG-EGFP or Tie2-Cre; Ail4 mice (60 days of age). Intestine tissue was selected because large amount of tissue is available for parallel comparison and the thin tissue wall makes it more sensitive to chemical treatment. After placing in the BB-PEG medium, the endogenous fluorescence intensity increased in the first week and maintained at the same intensity even one month later. The final fluorescent intensity was 30%-50% higher than the beginning (FIG. 2 I, j). The protective effects of the BB-PEG medium can be attributed to the presence of Poly(ethylene glycol) (PEG) because pure benzyl benzoate immediately quenched both GFP and tdTomato fluorescence (FIG. 10 a, b). PEG is a large chemical family with many different forms²⁰. Among the various PEGs tested, PEGMMA and PEG diacrylate (PEGDA) provided the best protection for endogenous fluorescence. Some preservation was also observed using unmodified PEG200, PEG400 and PEG1000 (FIG. 10 c, d).

### Example 4

### PEGASOS Method is Compatible with Immunofluorescent Staining, Isolectin and 5-Ethynyl-2′-Deoxyuridine (Edu) Labeling

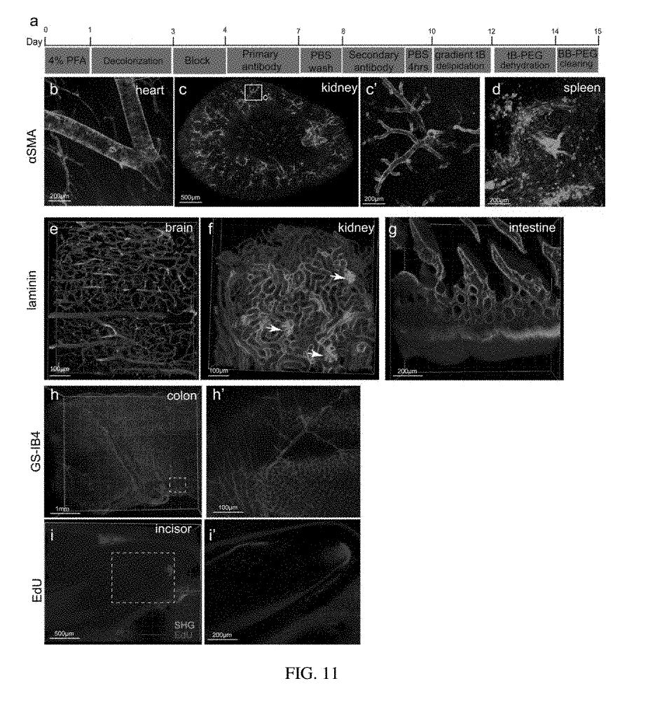

Whole-mount immunofluorescent staining of various soft tissue organs was performed and cleared using the PEGASOS immersion method afterwards (FIG. 11 a). αSMA antibody staining displayed the arterial organization within the heart, kidney and spleen (FIG. 11 b-d). Laminin staining revealed the vasculature within a brain slice, as well as tubules and renal corpuscles within the kidney and intestinal villi (FIG. 11 e-g).

Isolectin GS-IB4 (Alexa Fluor 568 conjugated) perfusion was performed for the mice and cleared the colon segment sample following the passive immersion procedure. GS-IB4 fluorescence was well preserved and optical sections revealed the vasculatures on the colon (FIG. 11 h, h′). EdU was injected in adult mice and mandible samples were collected two hours later. Whole-mount EdU staining was performed after decalcification and decolorization steps. The mandible sample was imaged with a two-photon microscope after clearing. Strong fluorescence with single cell resolution was observed at the apical region of the mouse incisor, which was known to contain highly proliferative cells (FIG. 11 i, i′).

### Example 5

### Both PEGASOS Recirculation and Passive Immersion Procedures can be Scaled Up for Clearing Large Animal Models

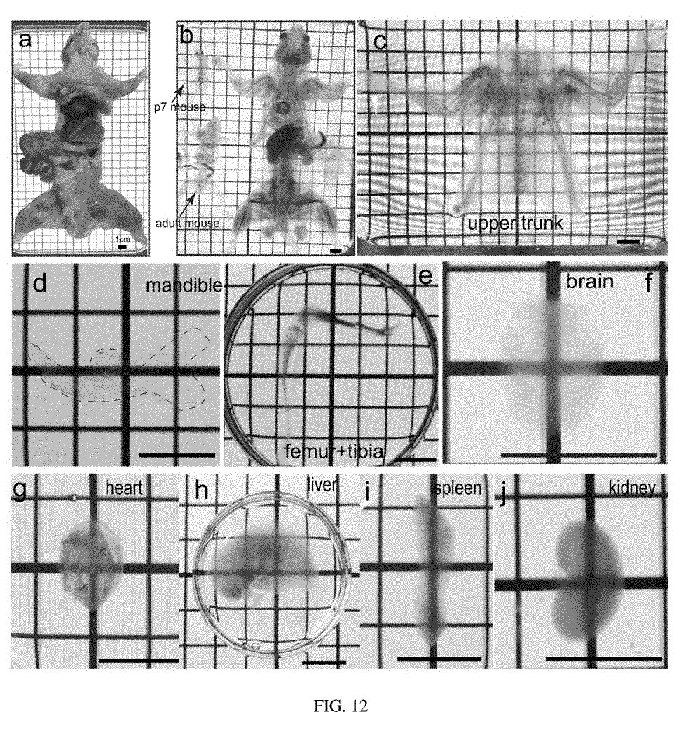

To test if the PEGASOS can be scaled up for larger animal, adult rats (12 weeks of age) were cleared with the recirculation procedure. Adult rats usually weigh over 300 grams, which is ten-fold heavier than adult mice. The entire clearing process took one month to finish with duration of each step being doubled. The rat turned highly transparent and its size also shrank significantly (FIG. 12 a, b). Body trunk was cleared with high transparency (FIG. 12 c). The rat mandible became nearly invisible (FIG. 12 d). Other organs including the femur, brain, heart, liver, spleen and kidney were all efficiently cleared to complete transparency (FIG. 12 e-j).

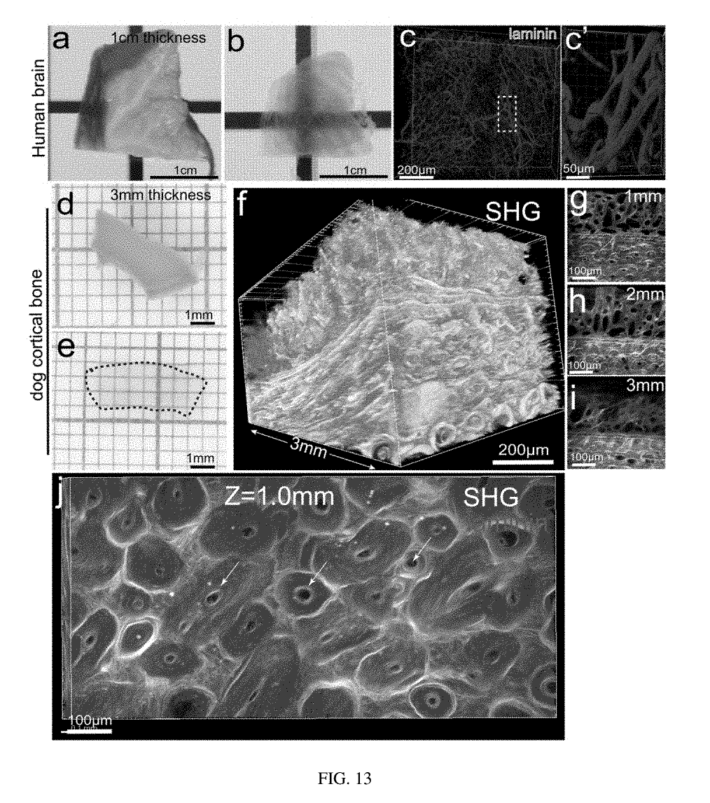

Fixed large human brain sample (3 cm×3 cm×1 cm) was cleared with the PEGASOS passive immersion procedure. The human brain sample turned transparent after clearing (FIG. 13 a, b). Laminin immunofluorescent staining was performed for a human brain slice of 1 mm thickness and imaged it after clearing. Vascular networks within the human brain were clearly visualized (FIG. 13 c, c′).

A piece of dog tibia cortical bone (1 cm×3 mm×3 mm) was cleared following the passive immersion procedure for hard tissue. The bone piece turned nearly invisible after clearing (FIG. 13 d, e). The sample was imaged with a two-photon microscope. SHG signal could be detected even at 3 mm depth (FIG. 13 f-i). Laminin staining was performed for a thin slice of bone sample (1 mm thickness) followed by clearing. Images acquired with a two-photon microscope revealed the Haversian Canals at the center of the osteons ((FIG. 13 j).

### Example 6

### Whole Brain Imaging and Tracing of Individual Neurons and Axons within the Intact Brains

Brains of adult Thy1-EGFP mice (60 days of age) were cleared following the passive immersion procedure for soft tissue organs. The dorsal-to-ventral thickness of the brain shrunk from ˜6 mm to ˜4 mm after processing. The entire brain was reconstituted with a 10×/0.50 objective on a confocal microscope by imaging from the dorsal-to-ventral direction. Neuron somas and axons were visualized throughout the entire brains including the cortex, hippocampus, cerebral peduncle and midbrain. (FIG. 3a, b, c, video 4).

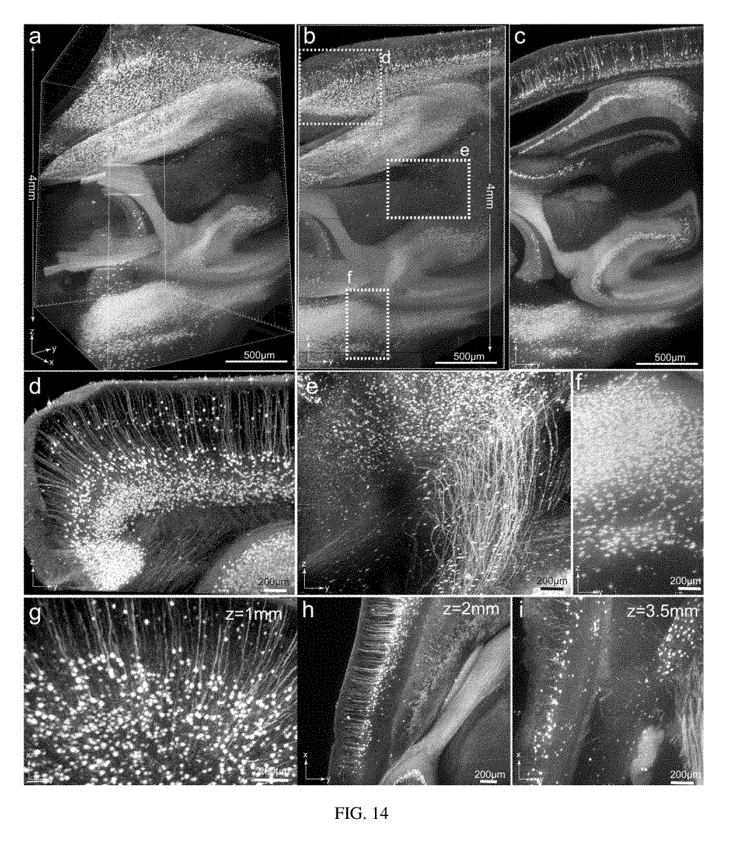

PEGASOS was further evaluated by imaging a cleared Thy1-yfp mouse brain with a 6×/0.25 objective on a light sheet microscope²¹. A 2 mm×2 mm×4 mm volume that goes through the entire ventral-to-dorsal direction of a cleared mouse brain was acquired within 8 mins, at a spatial resolution of ˜2 μm×2 μm×5 μm (FIG. 14 a). Optical sections obtained at various orientation and depth indicate single cell resolution was achieved through the entire imaging depth (FIG. 14 b-I).

The application of PEGASOS on mapping the brain connectome was explored. Although 10×/0.50 objective has a high lateral resolution of ˜0.5m, its axial resolution is only ˜5 μm²², which is not sufficient to trace axons (˜1 μm diameter) in 3-dimension. Therefore, intact Thy1-EGFP brain was imaged with a 20×/0.95 objective after clearing. Individual neurons were identified and one neuron was traced starting from the hippocampus region along its axon within the corpus callosum for 3 mm to near the midline area. The tracing was interrupted when the objective working distance limit of 1.95 mm was reached (Leica 20×/0.95 WD1.95 mm) (FIG. 3 d1-d4, video 5).

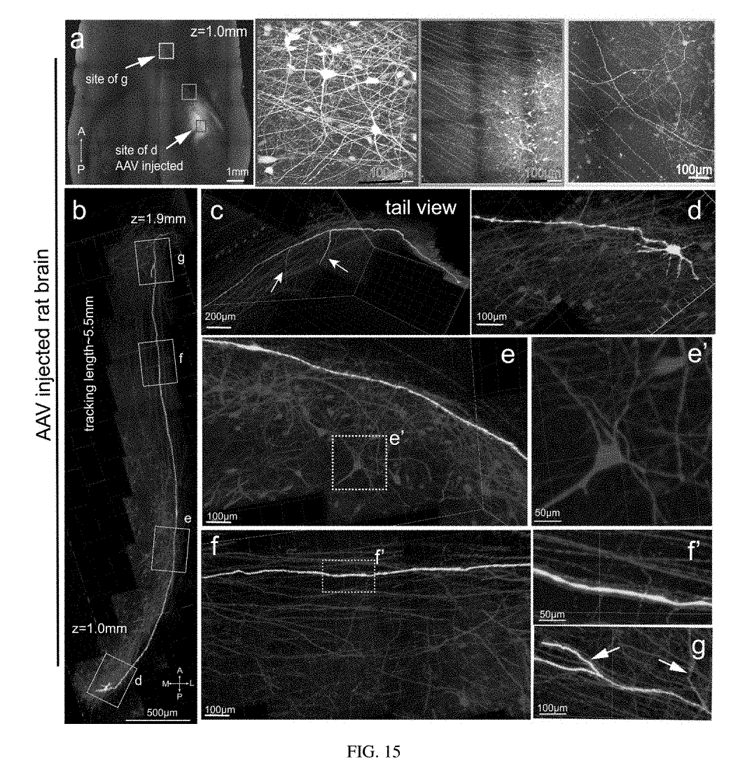

Adeno-associated virus (AAV) was injected into an adult rat (12 weeks of age) in the hippocampus CA1 region. One month later the rat was cleared following the recirculation procedure as described earlier. The intact brain was extracted for imaging (FIG. 15). Tiling images were obtained with a 5×/0.16 objective to display the injection site at 1 mm depth (FIG. 15 a). One individual neuron together with its axon projection was traced for a long distance with a 20×/0.95 objective (FIG. 15 b). A pyramidal neuron in the hippocampal region (z=1.0 mm) was selected for tracing. An axon arising from it could be identified and followed for up to 5.5 mm. The axon wound around in 3 dimensions and gave rise to several collateral branches at the end of the tracing. The tracing was interrupted near the midline when the working distance of the objective was reached (Leica 20×NA0.95 WD1.95 mm) (FIG. 15 10 c-g, video 6).

### Example 7

### Imaging the Connection Between the Central Nervous System (CNS) and the Peripheral Nervous System (PNS)

Dorsal root ganglions (DRGs) relay peripheral sensory information into the CNS. In previous clearing studies, the spinal cord was dissected from the vertebrae for imaging due to the opaqueness of the bone^{7, 23}. Connections between the DRG and spinal cord were not preserved in these studies.

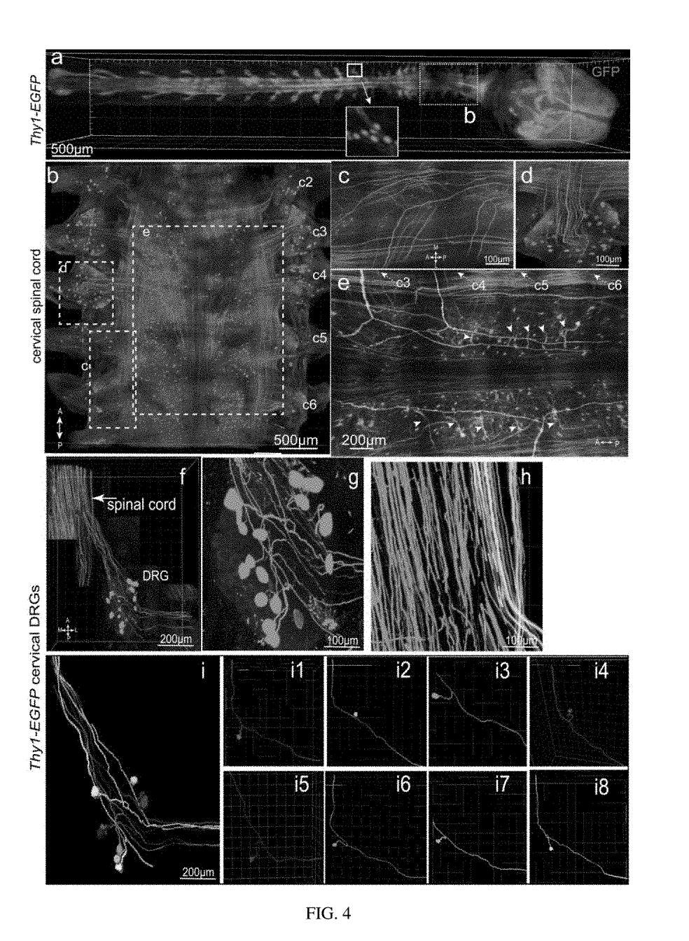

Adult Thy1-EGFP mice were cleared following the PEGASOS recirculation procedure. Due to the size limitation of the microscope stage, the vertebrae and brain were isolated for imaging. The entire CNS together with DRGs was imaged through the vertebrae, thereby preserving these delicate connections (FIG. 4 a). The cervical vertebrae segment was re-imaged with a 10×/0.45 objective on a confocal microscope. DRGs of C2˜C6 were clearly visualized within the intervertebral foramen (FIG. 4 b, video 7). Central axons originated from the DRGs were visualized, which gave rise to two daughter branches and more collateral branches (FIG. 4 c, d). Individual central axons together with their daughter branches were traced for over 2 cm within the spinal cord (FIG. 4 e, video 8).

To achieve better axial resolution, C4 DRG was re-imaged with a 20×/0.95 objective. The origin and bifurcation of every axon within the DRG was distinguish and each of the pseudo-unipolar neurons together with their axons were artificially labeled with different colors (FIG. 4 f, g, h, i1-i8, video 9).

### Example 8

### Innervation of the Long Bone Marrow Space

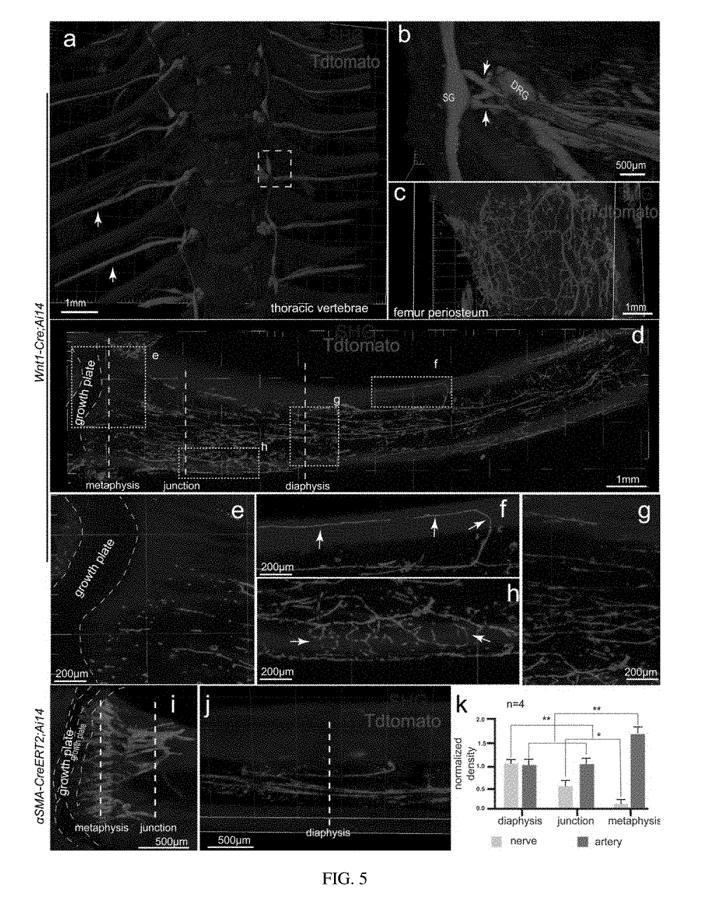

The Wnt1-Cre; Ail4 mouse model was used to label the PNS. A thoracic segment was isolated from a Wnt1-Cre; Ail4 mouse after clearing with the PEGASOS recirculation procedure. The sample was imaged with a 5×/0.16 objective. The SHG signal displayed the thoracic vertebrae and ribs. Sympathetic ganglia, DRG and spinal nerves and communication rami in between were also visualized, suggesting efficient labeling of both sympathetic and sensory nerves (FIG. 5 a, b). The intact tibia was cleared with the passive immersion procedure and was imaged with a 20×/0.95 objective. Nerve fibers were visualized on the bone surface (FIG. 5 c). The neural network within the tibia bone marrow space was visualized (FIG. 5 d, video 10). The major nerve bundles penetrate the cortical bone in the diaphysis region to enter the marrow space and branch out towards the growth plate (FIG. 5 e-h). The αSMA-Cre^{ERT}; Ail4 mouse model was used to investigate the arterial organization of the tibia marrow space. Major arterial branches could be seen in the shaft region of the tibia which then branched out towards the growth plate and no artery was seen penetrating it (FIG. 5 I, j). Interestingly, quantification indicates nerves are more enriched in the middle shaft region and are nearly absent from the trabecular bone, whereas the arteries density is higher near the growth plate and lower in the diaphysis area (FIG. 5 k).

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the numbers expressing quantities of ingredients, properties such as molecular weight, reaction conditions, and so forth, used to describe and claim certain embodiments of the application are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Embodiments of this application are described herein. Variations on those embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

### REFERENCES

1. Tainaka, K. et al. Whole-body imaging with single-cell resolution by tissue decolorization. Cell 159, 911-924 (2014).
2. Treweek, J. B. & Gradinaru, V. Extracting structural and functional features of widely distributed biological circuits with single cell resolution via tissue clearing and delivery vectors. Curr Opin Biotechnol 40, 193-207 (2016).
3. Greenbaum, A. et al. Bone CLARITY: Clearing, imaging, and computational analysis of osteoprogenitors within intact bone marrow. Sci Trans' Med 9 (2017).
4. Chung, K. & Deisseroth, K. CLARITY for mapping the nervous system. Nat Methods 10, 508-513 (2013).
5. Hama, H. et al. ScaleS: an optical clearing palette for biological imaging. Nat Neurosci 18, 1518-1529 (2015).
6. Treweek, J. B. et al. Whole-body tissue stabilization and selective extractions via tissue-hydrogel hybrids for high-resolution intact circuit mapping and phenotyping. Nat Protoc 10, 1860-1896 (2015).
7. Pan, C. et al. Shrinkage-mediated imaging of entire organs and organisms using uDISCO. Nat Methods 13, 859-867 (2016).
8. Erturk, A. et al. Three-dimensional imaging of solvent-cleared organs using 3DISCO. Nat Protoc 7, 1983-1995 (2012).
9. Chen, F., Tillberg, P. W. & Boyden, E. S. Optical imaging. Expansion microscopy. Science 347, 543-548 (2015).
10. Chung, K. et al. Structural and molecular interrogation of intact biological systems. Nature 497, 332-337 (2013).
11. Murray, E. et al. Simple, Scalable Proteomic Imaging for High-Dimensional Profiling of Intact Systems. Cell 163, 1500-1514 (2015).
12. Ke, M. T., Fujimoto, S. & Imai, T. SeeDB: a simple and morphology-preserving optical clearing agent for neuronal circuit reconstruction. Nat Neurosci 16, 1154-1161 (2013).
13. Li, W., Germain, R. N. & Gerner, M. Y. Multiplex, quantitative cellular analysis in large tissue volumes with clearing-enhanced 3D microscopy (Ce3D). Proc Natl Acad Sci USA (2017).
14. Rao, A. U., Carta, L. K., Lesuisse, E. & Hamza, I. Lack of heme synthesis in a free-living eukaryote. Proc Natl Acad Sci USA 102, 4270-4275 (2005).
15. Whiteaker, J. R., Fenselau, C. C., Fetterolf, D., Steele, D. & Wilson, D. Quantitative determination of heme for forensic characterization of bacillus spores using matrix-assisted laser desorption/ionization time-of-flight mass spectrometry. Anal Chem 76, 2836-2841 (2004).
16. Renier, N. et al. iDISCO: a simple, rapid method to immunolabel large tissue samples for volume imaging. Cell 159, 896-910 (2014).
17. Belle, M. et al. Tridimensional Visualization and Analysis of Early Human Development. Cell 169, 161-173 e112 (2017).
18. Erturk, A. et al. Three-dimensional imaging of the unsectioned adult spinal cord to assess axon regeneration and glial responses after injury. Nat Med 18, 166-171 (2011).
19. Craig, R. G. & Peyton, F. A. The micro-hardness of enamel and dentin. J Dent Res 37, 661-668 (1958).
20. Thomas, A., Muller, S. S. & Frey, H. Beyond poly(ethylene glycol): linear polyglycerol as a multifunctional polyether for biomedical and pharmaceutical applications. Biomacromolecules 15, 1935-1954 (2014).
21. Fu, Q., Martin, B. L., Matus, D. Q. & Gao, L. Imaging multicellular specimens with real-time optimized tiling light-sheet selective plane illumination microscopy. Nat Commun 7, 11088 (2016).
22. Susaki, E. A. et al. Advanced CUBIC protocols for whole-brain and whole-body clearing and imaging. Nat Protoc 10, 1709-1727 (2015).
23. Yang, B. et al. Single-cell phenotyping within transparent intact tissue through whole-body clearing. Cell 158, 945-958 (2014).
24. Schwarz, M. K. et al. Fluorescent-protein stabilization and high-resolution imaging of cleared, intact mouse brains. PLoS One 10, e0124650 (2015).
25. de Lencastre Novaes, L. C., Mazzola, P. G., Pessoa, A., Jr. & Penna, T. C. Effect of polyethylene glycol on the thermal stability of green fluorescent protein. Biotechnol Prog 26, 252-256 (2010).
26. Muhammad, N., Kryuchkova, N., Dworeck, T., Rodriguez-Ropero, F. & Fioroni, M. Enhanced EGFP fluorescence emission in presence of PEG aqueous solutions and PIB1000-PEG6000-PIB1000 copolymer vesicles. Biomed Res Int 2013, 329087 (2013).
27. Kuwajima, T. et al. ClearT: a detergent- and solvent-free clearing method for neuronal and non-neuronal tissue. Development 140, 1364-1368 (2013).
28. Tainaka, K., Kuno, A., Kubota, S. I., Murakami, T. & Ueda, H. R. Chemical Principles in Tissue Clearing and Staining Protocols for Whole-Body Cell Profiling. Annu Rev Cell Dev Biol 32, 713-741 (2016).
29. Kubota, S. I. et al. Whole-Body Profiling of Cancer Metastasis with Single-Cell Resolution. Cell Rep 20, 236-250 (2017).
30. Morrison, S. J. & Scadden, D. T. The bone marrow niche for haematopoietic stem cells. Nature 505, 327-334 (2014).
31. Zhao, H. et al. Secretion of shh by a neurovascular bundle niche supports mesenchymal stem cell homeostasis in the adult mouse incisor. Cell Stem Cell 14, 160-173 (2014).
32. Katayama, Y. et al. Signals from the sympathetic nervous system regulate hematopoietic stem cell egress from bone marrow. Cell 124, 407-421 (2006).
33. Hanoun, M., Maryanovich, M., Arnal-Estape, A. & Frenette, P. S. Neural regulation of hematopoiesis, inflammation, and cancer. Neuron 86, 360-373 (2015).
34. Zhou, B. O., Yue, R., Murphy, M. M., Peyer, J. G. & Morrison, S. J. Leptin-receptor-expressing mesenchymal stromal cells represent the main source of bone formed by adult bone marrow. Cell Stem Cell 15, 154-168 (2014).
35. Butler, S. J. & Bronner, M. E. From classical to current: analyzing peripheral nervous system and spinal cord lineage and fate. Dev Biol 398, 135-146 (2015).
36. Smith, G. M., Falone, A. E. & Frank, E. Sensory axon regeneration: rebuilding functional connections in the spinal cord. Trends Neurosci 35, 156-163 (2012).
37. Kandel, E. R., Markram, H., Matthews, P. M., Yuste, R. & Koch, C. Neuroscience thinks big (and collaboratively). Nat Rev Neurosci 14, 659-664 (2013).
38. Li, N., Chen, T. W., Guo, Z. V., Gerfen, C. R. & Svoboda, K. A motor cortex circuit for motor planning and movement. Nature 519, 51-56 (2015).
39. Economo, M. N. et al. A platform for brain-wide imaging and reconstruction of individual neurons. Elife 5, e10566 (2016).

What is claimed is:

1. A tissue clearing solution comprising a PEG, an organic ester, and a polyol.

2. The solution of claim 1 comprising PEG, benzyl benzoate, and Quadrol.

3. The solution of claim 2 comprising 65%-85% benzyl benzoate, 15%-30% PEG, and 0.5%-10% Quadrol.

4. The solution of claim 3 comprising 75 vol % benzyl benzoate (BB), 22 vol % PEGMMA and 3 vol % Quadrol.

5. A kit for tissue clearing comprising the solution of claim 1.

6. The kit of claim 5 further comprising one or more of fixation reagent(s), decalcification reagent(s), decolorization reagent(s), delipidation reagent(s), dehydration reagent(s) and/or clearing reagent(s).

7. The kit of claim 6 further comprising decalcification reagent(s).

8. A method for clearing a tissue, comprising the steps of:
a. Isolating the tissue,
b. Fixing the tissue in a fixing solution,
c. Decolorizing the tissue in a decolorizing solution,
d. Delipidating the tissue in a delipidating solution,
e. Dehydrating the tissue in a dehydration solution, and
f. Clearing the tissue in the tissue clearing solution of claim 1;
wherein the tissue becomes partially or completely transparent.

9. The method of claim 8 further comprising a step of decalcifying the tissue with a decalcification solution.

10. The method of claim 8, wherein the tissue comprises brain, heart, spleen, kidney or liver.

11. The method of claim 7, wherein the tissue comprises bone or teeth.

12. A method for clearing a whole body or large body part, comprising the steps of
a. Fixing the body or large body part,
b. Decalcifying the body or large body part,
c. Decolorizing the body or large body part,
d. Delipidating the body or large body part,
e. Dehydrating the body or large body part, and
f. Clearing the body or large body part;
wherein the whole body or large body part becomes partially or completely transparent.

13. The method of claim 12, wherein chemical reagents are infused through a perfusion needle to access the whole body or body part.
